(19) United States
(12) Patent Application Publication
(10) Pub. No.: US 2014/0278813 A1
(43) Pub. Date: Sep. 18, 2014

(54) RECOMMENDATION ENGINE

(71) Applicant: INTERNATIONAL BUSINESS MACHINE CORPORATION, Armonk, NY (US)

(72) Inventors: Robin N. Grosset, Ottawa (CA); Robert Y. Nonez, Orleans (CA); Graham A. Watts, Ottawa (CA)

(73) Assignee: INTERNATIONAL BUSINESS MACHINES CORPORATION, Armonk, NY (US)

(21) Appl. No.: 13/836,950

(22) Filed: Mar. 15, 2013

(51) Int. Cl. G06Q 10/06

(52) U.S. Cl. CPC G06Q 10/0637
USPC 705/7.36

(57) ABSTRACT

Techniques of the disclosure may include a method comprising receiving a first request for a recommendation to configure input data for output, determining, based at least in part upon templates, an object class corresponding to the first request, determining, based at least in part on input data and the templates, one or more output objects and one or more scores, wherein the output objects comprise configurations of the input data for the determined object class, and where each of the output objects is associated with a score. The method may further comprise outputting a indication of the output objects having an associated score that exceeds a specified threshold value, responsive to receiving a second request to resolve a specified output object, determining, based at least in part on the one or more templates and the second request, a resolved output object and outputting an indication of the resolved output object.

### FIELD OF INVENTION

This disclosure relates to techniques for providing template-driven output in an enterprise software system.

### BACKGROUND

Enterprise software systems are typically sophisticated, large-scale systems that support many, e.g., hundreds or thousands, of concurrent users. Examples of enterprise software systems include financial planning systems, budget planning systems, order management systems, inventory management systems, sales force management systems, business intelligence tools, enterprise reporting tools, project and resource management systems, and other enterprise software systems.

Many enterprise performance management and business planning applications require a large base of users to enter data that the software then accumulates into higher-level areas of responsibility in the organization. Often these complex systems make use of multidimensional data sources that organize and manipulate the tremendous volume of data using data structures referred to as data cubes. A data cube may, for example, include a plurality of hierarchical dimensions having levels and members for storing the multidimensional data. Once data has been entered, a user may wish to view some or all of the data in a coherent manner by generating a report. The system may perform mathematical calculations on the data and combine data submitted by many users. Using the results of these calculations, the system may generate reports for review by higher management.

The use of reporting and analysis end-user products (typically referred to as Business Intelligence, or BI, tools) allows users to author reports and perform data exploration and analysis on a myriad of data sources, such as multidimensional data structures, relational databases, flat files, Extensible Markup Language (“XML”) data, data streams, and unorganized text and data. Business intelligence tools may be used to prepare and aggregate individual reports and analyses by executing queries on underlying data sources and to present those reports and analyses in a user-accessible format.

### SUMMARY

In one example, a computer-implemented method includes receiving, by a computing device, a first request for a recommendation to configure input data for output, wherein the first request comprises the input data, determining, by the computing device and based at least in part upon one or more templates, an object class corresponding to the first request, determining, by the computing device and based at least in part on the input data and the one or more templates, one or more output objects and one or more scores, wherein the one or more output objects each comprise a configuration of the input data for the determined object class, and wherein each of the one or more output objects is associated with a score of the one or more scores. The method may further comprise outputting, by the computing device, a first indication of the one or more output objects, each output object having an associated score that exceeds a specified threshold value, responsive to receiving a second request to resolve a specified output object of the one or more output objects, determining, by the computing device and based at least in part on the one or more templates and the second request, a resolved output object, and outputting, by the computing device, a second indication of the resolved output object.

In another example, a computing device comprises at least one processor, and a user interface module operable by the at least one processor to receive a first request for a recommendation to configure input data for output, wherein the first request comprises the input data. The computing device may further comprise a recommendation engine operable by the at least one processor to determine, based at least in part upon one or more templates, an object class corresponding to the first request, and determine, based at least in part on the input data and the one or more templates, one or more output objects and one or more scores, wherein the one or more output objects each comprise a configuration of the input data for the determined object class, and wherein each of the one or more output objects is associated with a score of the one or more scores. The user interface module may be further operable by the at least one processor to output a first indication of the one or more output objects having an associated score that exceeds a specified threshold value, and receive a second request to resolve a specified output object of the one or more output objects. The recommendation engine may be further operable by the at least one processor to determine, based at least in part on the one or more templates and the second request, a resolved output object and the user interface module may be further operable by the at least one processor to output a second indication of the resolved output object.

In another example, a computer program product comprises a computer readable storage medium having program code embodied therewith, the program code executable by a computing device to perform a method comprising receiving, by the computing device, a first request for a recommendation to configure input data for output, wherein the first request comprises the input data, determining, by the computing device and based at least in part upon one or more templates, an object class corresponding to the first request, determining, by the computing device and based at least in part on the input data and the one or more templates, one or more output objects and one or more scores, wherein the one or more output objects each comprise a configuration of the input data for the determined object class, and wherein each of the one or more output objects is associated with a score of the one or more scores. The method may further comprise outputting, by the computing device, a first indication of the one or more output objects having an associated score that exceeds a specified threshold value. The method may further comprise, responsive to receiving a second request to resolve a specified output object of the one or more output objects, determining, by the computing device and based at least in part on the one or more templates and the second request, a resolved output object and outputting, by the computing device, a second indication of the resolved output object.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example computing environment in which a plurality of users interact with an enterprise business intelligence system, in accordance with one or more aspects of the present disclosure.

FIG. 2 is a block diagram illustrating one example of a computing device that may interact with the enterprise business intelligence system of FIG. 1, in accordance with one or more aspects of the present disclosure.

FIG. 3 is a block diagram illustrating example operations that may be performed by a recommendation engine, in accordance with one or more aspects of the present disclosure.

FIG. 4 is a block diagram illustrating an example graphical user interface (GUI) for providing a recommendation engine, in accordance with one or more aspects of the present disclosure.

FIG. 5 is a flowchart illustrating an example process for providing a recommendation, in accordance with one or more aspects of the present disclosure.

### DETAILED DESCRIPTION

FIG. 1 illustrates an example context in which one or more of the techniques disclosed herein may be used. FIG. 1 is a block diagram illustrating an example enterprise 4 in which a plurality of users 12A-12N (collectively “users 12”) may interact with an enterprise business intelligence system 14, in accordance with one or more aspects of the present disclosure. As shown in the example system of FIG. 1, enterprise business intelligence system 14 may be communicatively coupled to a number of computing devices 16A-16N (collectively “computing devices 16”) via enterprise network 18. Users 12 interact with their respective computing devices to access enterprise business intelligence system 14 in order to input, modify, and review data. In one example, users 12 may use computing devices 16 to access enterprise business intelligence system 14 and author one or more reports 17. Reports 17 may include business intelligence reports, such as sales reports, revenue reports, payroll reports, and the like. Enterprise business intelligence system 14 may provide users 12 with functionality to create or define a structure for reports 17 using report specifications and/or queries. Computing devices 16A-16N, enterprise network 18, and enterprise business intelligence system 14 may all be either in a single facility or widely dispersed in two or more separate locations anywhere in the world, in different examples.

For purposes of illustration only, various techniques of the present disclosure are described with respect to generation of reports and/or report specifications. However, certain examples of the techniques of this disclosure may be readily applied to various software systems executed by various devices, including enterprise business intelligence systems, other large-scale enterprise software systems, as well as single-user and/or stand-alone software applications. Examples of enterprise software systems include enterprise financial or budget planning systems, order management systems, inventory management systems, sales force management systems, business intelligence tools, enterprise reporting tools, project and resource management systems, and other enterprise software systems. Other example applications include graphical design applications, email applications, spreadsheet applications, or other applications in which users may benefit from a choice of one or more ranked options to determine an output. For instance, various techniques of this disclosure may be readily applied by computing devices for generating properly structured queries (e.g., to a database). That is, administrators or developers of a recommendation engine as described herein may provide class definitions, rules, and/or templates that define possible structures of a query, as well as various criteria for ranking each structure, based on what data is to be retrieved by the query. Each user may then utilize the recommendation engine to provide input regarding what data is desired to be retrieved by a query and receive a ranked ordering of potentially appropriate query structures based on the specified data. The user may then choose a presented option and receive a properly structured, generated query and/or the results of the query.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In the example of FIG. 1, users 12 may interact with a user-configurable business intelligence user interface (UI) to view and manipulate data (e.g., generate reports 17) via their respective computing devices 16. This may include data from any of a wide variety of sources, including from multidimensional data structures and relational databases within enterprise 4, as well as data from a variety of external sources that may be accessible over a public network. Multidimensional data structures are “multidimensional” in that each multidimensional data element is defined by a plurality of different object types, where each object is associated with a different dimension. Users 12 may, for example, retrieve data related to store sales by entering a name of a sales person, a store identifier, a date, a product, and a price at which the product was sold, into their respective computing devices 16.

Enterprise users 12 may use a variety of different types of computing devices 16 to utilize a business intelligence UI and to generate business intelligence reports 17 or otherwise interact with enterprise business intelligence system 14 via enterprise network 18. For example, an enterprise user 12 may utilize a business intelligence UI and interact with enterprise business intelligence system 14 using a laptop computer, desktop computer, or the like, which implements a web browser. Alternatively, an enterprise user 12 may use a smartphone or similar device, utilizing a business intelligence UI in either a web browser or a dedicated mobile application for interacting with enterprise business intelligence system 14. Further examples of computing devices 16 may include workstation computers, netbooks, tablet computers, E-readers, or any other such computing device. In either case, a business intelligence UI running on a user's computing device 16 may access various data sources from within enterprise business intelligence system 14, as well as any of a variety of external network resources and any of a variety of external data sources.

Enterprise network 18 may represent any communication network, such as a packet-based digital network like a private enterprise intranet or a public network like the Internet. In this manner, enterprise network 18 can readily scale to suit large enterprises. Enterprise users 12 may directly access enterprise business intelligence system 14 via a local area network, or may remotely access enterprise business intelligence system 14 via a virtual private network, remote dial-up, or similar remote access communication mechanism.

The business intelligence UI running on a user's computing device 16 may use retrieved data to generate one or more reports 17. Reports 17 may include any visual representation or depiction of data such as tables, charts, graphs, or other methods of disseminating information. For example, reports 17 may include a graph with sales values assigned to a vertical axis, and time values assigned to a horizontal axis, a chart of revenue values recorded for various sales regions, a table of payroll data values recorded for different enterprise locations, a graph of enterprise spending by department, and the like. Users 12 may interact with computing devices 16 to generate reports 17 by selecting different data elements and/or dimensions to display in reports 17.

Reports 17 may be generated based on report specifications. Generally, report specifications may determine the type, layout, quantity, categories, or other characteristics of data elements included in reports 17. That is, report specifications may be a configuration of the data elements to be included. Examples of report specifications may include a document used by one of computing devices 16 to generate a graphical pie chart depicting the desired data elements, a bar graph displaying various categories of the desired data elements, a crosstab displaying values for intersecting dimensions, or other representations of the data elements.

For a given set of data, there may be many possible report specifications for visualizing the data, all having their own benefits and drawbacks relative to one another. Each report specification may also have various report options, which can also have benefits and drawbacks. In order to choose a representation for reports and analyses, a user may require extensive knowledge of the report data as well as the different types of reports and analyses available. Additionally, business intelligence tools may require the user to employ complex query language or advanced functionality to define data sources to include when generating a report, performing an analysis, or in various other situations. For example, a set of data containing sales amounts, products and time may be represented as a line chart, a bar chart or even a set of pie charts within one of reports 17. A set of pie charts may, in some instances, be considered a poor choice as it is hard to read the values from the chart. In contrast, a line chart may be a better choice, as it may show change over time well if the time dimension is placed on the X, or horizontal, axis. The line chart may still be a valid chart when the time dimension is not on the X-Axis, but in such a circumstance, the line chart may be less insightful to users 12. In addition to report generation, creation of various other example objects may suffer when determining an output from a large number of potential outputs.

Templates may be one way to externalize the potential outputs of a rule based system, such as, for example, report specifications. Using templates may allow developers or system administrators of enterprise 4 to add new outputs to a system for configuring input data. Such templates may utilize a rule-based language to define how information from the system (e.g., input data) is mapped into the template to produce an output. One such example language is eXtensible Stylesheet Language Transformations (XSLT), which is a template language describing how an eXtensible Markup Language (XML) input is mapped to a different XML output. A transformation engine may then be used to produce an output from the template. However, this process of using a template to configure the input data may be deterministic. That is, for a given input, there may be only a single expected output without allowing any input from a user. While templates may describe complex transformations and conditions to apply to the input in order to produce the output, the result is typically still a single, resolved output for any given set of inputs. In examples such as report generation, where a given set of inputs can produce many potential outputs, each with varying degrees of insight, a single output may be restrictive.

In the example of report generation, an administrator may provide a class definition, rules, and/or templates for generating report specifications. A computing device may process the class definitions, rules, and/or templates and generate a knowledge base. The computing device may receive a first request for a recommendation to configure input data for output. The first request may include the input data as part of the request. The computing device may determine an object class that corresponds to the first request, based at least in part upon the knowledge base (e.g., the report classes, rules, and/or templates). The computing device may determine one or more output objects and scores each corresponding to one of the one or more output objects, based at least in part on the input data and the knowledge base. In some examples, the one or more output objects are each a configuration of the input data for the determined object class. The computing device may output an indication of the one or more output objects having associated scores exceeding a specified threshold value. Responsive to receiving a second request to resolve a specified output object of the one or more output objects, the computing device may determine, based at least in part on the knowledge base and the second request, a resolved output object. The computing device may output an indication of the resolved output object.

Various techniques of the present disclosure may provide a set of programmatic components that, together, comprise a recommendation engine able to read one or more templates for configuring input data, determine the criteria to be satisfied to resolve the template(s), as well as the various ways those criteria can be satisfied, and score each possibility so a ranked set of potential resolutions can be returned. The recommendation engine itself may, in certain non-limiting examples, know nothing about the input, outputs, or rules. That is, the recommendation engine may simply execute on the input data and the rules described in the templates in order to rank and produce the potential outputs. This allows all the logic that determines what is, and can be, returned from the system to be fully externalized. Such a system may be configured and enhanced by administrators or developers (e.g., by applying a software update), or by users themselves by extending or writing new templates.

By providing serialization keys that describe each potential output and that can be used to recreate all or part of the resolution of that potential output, a template may be resolved to a single output, while still allowing the choice to be presented to users 12, or stored, without necessarily incurring the cost of resolving each template to a final output. A template and a single key may, together, provide only a single resolved output. In contrast, one or more techniques of the present disclosure may use the set of all keys, along with their scores, to provide the complete spectrum of ranked choices to a user. That is, techniques of the present disclosure may improve quality and ease of report generation, as well as other tasks in which users may benefit from receiving assistive recommendations, by providing an externalized, template-driven, nondeterministic recommendation engine that administrators or other entities may employ to assist users.

FIG. 2 is a block diagram illustrating one example of a computing device 16A that may interact with the enterprise business intelligence system 14 of FIG. 1, in accordance with one or more aspects of the present disclosure. Computing device 16A includes one or more processors 20, one or more memory units 21, and one or more storage devices 22. In addition, computing device 16A includes network interface 24, query module 26, report module 28, recommendation engine 30, user interface (UI) module 32, one or more output devices 34, and one or more input devices 36. While shown as separate components in FIG. 2, operations performed by one or more of network interface 24, modules 26, 28, and 32, as well as recommendation engine 30, and/or devices 34 and 36 may be performed by a single module or device, or other number of modules or devices in various examples. Storage devices 22 may contain class definitions 38, rules 39 and templates 40, as shown in FIG. 2. In other examples, storage devices 22 may contain other components of computing device 16A, such as one or more data cubes.

In some examples, one or more components, such as query module 26, report module 28, and/or recommendation engine 30, may be part of enterprise business intelligence system 14 or other device of enterprise 4 (e.g., connected to enterprise network 18). Additionally, while class definitions 38, rules 39, and templates 40 are shown in FIG. 2 as being stored by computing device 16A, class definitions 38, rules 39, and/or templates 40 may, in other examples, be stored in one or more storage devices of enterprise business intelligence system 14, or any other device of enterprise 4. That is, in some examples, computing device 16A may communicate with one or more other devices via enterprise network 18 to provide requests for recommendations to recommendation engine 30, receive recommended objects from recommendation engine 30, provide a selection of one or more recommended objects, and/or receive generated output.

Processors 20, in one example, are configured to implement functionality and/or process instructions for execution in computing device 16A. For example, processors 20 may be capable of executing instructions of various components of computing device 16A, such as modules 26, 28, and 32, as well as recommendation engine 30. Examples of processors 20 may include, any one or more of a microprocessor, a controller, a digital signal processor (DSP), an application specific integrated circuit (ASIC), a field-programmable gate array (FPGA), or equivalent discrete or integrated logic circuitry.

One or more memory units 21 may be configured to store information in computing device 16A during operation. Memory units 21, in some examples, are a temporary memory, meaning that a primary purpose of memory units 21 is not long-term storage. In other examples, memory units 21 include one or more computer-readable storage media. Memory units 21, in some examples, are described as volatile memory, meaning that memory units 21 do not maintain stored contents when the computer is turned off. Examples of volatile memories include random access memories (RAM), dynamic random access memories (DRAM), static random access memories (SRAM), and other forms of volatile memories known in the art. In some examples, memory units 21 are used to store program instructions for execution by processors 20. Memory units 21, in one example, are used by software or applications running on computing device 16A (e.g., modules 26 and 28 or recommendation engine 30) to temporarily store information during program execution.

Storage devices 22, in some examples, include one or more computer-readable storage media. Storage devices 22 may be configured to store larger amounts of information than volatile memory. Storage devices 22 may further be configured for long-term storage of information. In some examples, storage devices 22 include non-volatile storage elements. Examples of non-volatile storage elements include magnetic hard discs, optical discs, floppy discs, flash memories, or forms of electrically programmable memories (EPROM) or electrically erasable and programmable memories (EEPROM). In the example of FIG. 2, storage devices 22 may store class definitions 38, rules 39, and templates 40 for use during operation of computing device 16A. In some examples, such as during operation, class definitions 38, rules 39, and/or templates 40 may be stored in memory units 21 instead of, or in addition to being stored in storage devices 22. That is, in some examples, memory units 21 may be one example of storage devices 22.

In some examples, memory units 21 and/or storage devices 22 may include one or more data cubes. Data cubes may store data from user 12A and/or from data sources of enterprise business intelligence system 14 via enterprise network 18. Data stored in the data cubes may provide the underlying data for computing device 16A to define report specifications and/or create reports 17. Data cubes, in some examples, may include two-dimensional databases and/or multidimensional databases, i.e., cubes. Data cubes may be implemented using a variety of vendor platforms, and may be distributed throughout the enterprise via network interface 24. As one example, the data cubes may be multidimensional databases configured for Online Analytical Processing (OLAP). As another example, the data cubes may be multidimensional databases configured to receive and execute Multidimensional Expression (MDX) queries of some arbitrary level of complexity. As yet another example, the data cubes may be two-dimensional relational databases configured to receive and execute SQL queries, also with an arbitrary level of complexity. Storing the data cubes locally within memory units 21 and/or storage devices 22 may allow some or all calculation performed as part of defining report specifications and generating reports 17 to be performed locally by computing device 16A. In other examples, computing device 16A may not store the data cubes locally, and one or more devices, such as enterprise business intelligence system 14 may perform the calculation.

Computing device 16A, in some examples, includes network interface 24. Network interface 24 may provide functionality to communicate with external devices, such as enterprise business intelligence system 14, via one or more networks (e.g., enterprise network 18). Network interface 24 may include a network interface card, such as an Ethernet card, an optical transceiver, a radio frequency transceiver, or any other type of device that can send and receive information. Other examples of such network interfaces may include 3G and WiFi radio components, as well as Universal Serial Bus (USB). In some examples, computing device 16A utilizes network interface 24 to communicate with enterprise business intelligence system 14 when sending or receiving multidimensional data, such as when retrieving data for reports 17.

In the example of FIG. 2, computing device 16A may include one or more class definitions 38 within storage devices 22. One or more of class definitions 38 may, in some examples, include an object class, a class name, an indication of one or more base classes, a parameter tree definition, and/or one or more named output types. The object class of a class definition may indicate the objects to which the class definition may apply, such as report specification objects or query objects. In some examples, only objects of the same class will be ranked relative to one another. Base classes may define a parent class or classes from which the present class definition may inherit properties. The parameter tree definition may define a parameter tree, and include a definition section, a scoring section, and a validation section. For each of class definitions 38, the three parameter tree definition sections may be parsed, and a single parameter tree may be created for a class. Parameter trees are further described with respect to FIG. 3 below.

An output type, as defined in a class definition, may be a sub-type of an object class. For instance, the class definition for report specifications may apply to report specification objects, and may contain output types such as a bar chart, a crosstab, a pie chart, or other types of output. Criteria for each output type within one of class definitions 38 may be defined inline (e.g., by the output type within the class definition), or by reference to a separate template file (e.g., within templates 40). That is, each of class definitions 38 may define various output types of an object class, either though reference or inline definition, according to some examples.

Computing device 16A, in some examples, may include one or more rules 39 within storage devices 22. Rules 39 may include definitions or methods usable by one or more parameters. That is, in some examples, rules 39 may include generalized definitions, operations, and/or parameter interfaces that are not parameter-specific. Rules 39 are further described with respect to FIG. 3 below.

In the example of FIG. 2, computing device 16A may include one or more templates 40 within storage devices 22. Templates 40 may be used by recommendation engine 30 to generate an output for a specific object class and output type. Templates may contain a mix of static content interspersed with control statements. Static content may, in some examples, be copied directly to the output, while control statements may define actions to take with respect to data in order to determine content to be copied to the output. Templates 40 are further described with respect to FIG. 3 below.

Class definitions 38, rules 39, and/or templates 40 may be formatted using one or more computer-readable languages, such as eXtensible Markup Language (XML), Java, C, Hypertext Markup Language (HTML), or other language. That is, class definitions 38, rules 39, and/or templates 40 may be XML files, Java classes, C libraries, or other file type. Other non-limiting example formats for class definitions 38, rules 39, and/or templates 40 include XML Path Language (XPath), Structured Query Language (SQL), or JavaScript.

Computing device 16A, in some examples, includes query module 26. Query module 26 may include instructions operable by processors 20 via memory units 21 to generate queries used to obtain data from enterprise business intelligence system 14 via enterprise network 18. For instance, query module 26 may receive a request (e.g., from report module 28, or user 12A) to generate one or more queries for specific data elements within multidimensional data of enterprise 4. In some examples, query module 26 may generate one or more queries and retrieve relevant enterprise data from locally stored data cubes and/or from data cubes of enterprise business intelligence system 14 via network interface 24. In other examples, query module 26 may communicate with recommendation engine 30 to cause recommendation engine 30 to generate queries in accordance with one or more techniques of the present disclosure. That is, query module 26 may send a request providing input data (e.g., the desired results of a query) to recommendation engine 30 and receive configurations of the input data (e.g., potential structures for one or more queries). In some examples, the received potential structures may be ranked (e.g., in order of recommendation). Query module 26 may provide the potential query structures to user 12A (e.g., via UI module 32) for consideration. Query module 26 may receive a selection of a potential query structure, provide the selection to recommendation engine 30, and receive the generated query. The results of queries performed by query module 26 may be sent to other components associated with computing device 16A, such as report module 28 or recommendation engine 30.

Computing device 16A, in some examples, may include report module 28. Report module 28 may include instructions operable by processors 20 via memory units 21 to generate reports 17 based on report specifications. Report specifications may be one or more documents used by computing device 16A (e.g., stored on storage devices 22) that provide the structure and content of reports 17. In some examples, report specifications may include documents or files containing markup language (e.g., XML) instructions defining various criteria for a report. That is, report specifications may be configurations of data (e.g., input data) to be included in a report. For instance, a report specification may define the layout of various charts and tables to be displayed in a report. Report specifications may include one or more definitions specifying which data element or elements are to be included in parts of reports 17. The definitions within the report specifications may be created in a query language, (e.g., SQL), and may be executable by components of computing device 16A to cause retrieval of the defined data elements from underlying data sources. As one example, a definition may generate a line graph-type report, cause the report to include all data elements belonging to a particular hierarchy, and cause the report to display markers for each included data point in the line graph.

Report module 28 may, in some examples, communicate with recommendation engine 30 to cause recommendation engine 30 to generate report specifications in accordance with one or more techniques of the present disclosure. For instance, report module 28 may send a request to recommendation engine 30 providing input data (e.g., data elements to be included in a report) and receive configurations of the input data (e.g., potential report specifications) for generating one or more reports 17. Report module 28 may provide an indication of the potential report specifications to UI module 32. UI module 32 may output a GUI (e.g., at output devices 34) displaying one or more potential report specifications for consideration by user 12A. UI module 32 may receive an indication of a selection of a potential report specification (e.g., at one of input devices 36) and send the indication to Report module 28. Report module 28 may provide the selection to recommendation engine 30, and receive the generated report specification from recommendation engine 30. Report module 28 may generate one or more of reports 17 based on the received report specification. In the example of FIG. 2, report module 28 outputs reports 17 locally at computing device 16A. In other examples, report module 28 may output reports 17 to enterprise business intelligence system 14, or to others of computing devices 16 via network interface 24.

As shown in the example of FIG. 2, computing device 16A may include UI module 32. UI module 32 may include instructions operable by processors 20 via memory units 21 to interact with output devices 34 and/or input devices 36 to provide an interface to user 12A enabling selection of various data elements from the multidimensional enterprise data and/or creation of one or more reports 17. That is, UI module 32 may display a GUI (e.g., at one or more of output devices 34) with which user 12A can interact (e.g., by using one or more of input devices 36) to cause computing device 16A to create report specifications and/or generate reports 17.

UI module 32 may output information to user 12A via one or more of output devices 34 operatively coupled to computing device 16A. Output devices 34, in some examples, are configured to provide output to a user using tactile, audio, or video stimuli. Output devices 34 may include a presence-sensitive display, a sound card, a video graphics adapter card, or any other type of device for converting a signal into an appropriate form understandable to humans or machines. Additional examples of output devices 34 include a speaker, a cathode ray tube (CRT) monitor, a liquid crystal display (LCD), or any other type of device that can generate intelligible output to a user. UI module 32 may receive input from user 12A via one or more input devices 36. Input devices 36 may be part of computing device 16A, or may be communicatively coupled to computing device 16A. Input devices 36 may include a keyboard, a mouse, a touch-sensitive or presence-sensitive display, a stylus, or any device operable to provide machine input.

As shown in the example of FIG. 2, computing device 16A may include recommendation engine 30. Recommendation engine 30 may include instructions operable by processors 20 via memory units 21 to access storage device 22, retrieve class definitions 38, rules 39, and/or templates 40, and generate a knowledge base. The knowledge base may define possible structures and options for various classes of objects, as well as define methods or criteria for scoring the possible structures for each class. For instance, in the example of FIG. 2, class definitions 38, rules 39, and templates 40 may each include files corresponding to a report specification class and/or files corresponding to a query class. In other examples, class definitions 38, rules 39, and/or templates 40 may include files corresponding to various other classes. Recommendation engine 30 may store the generated knowledge base (e.g., in storage devices 22) for later use in providing recommendations.

Recommendation engine 30 may receive input from other components of computing device 16A (e.g., from one or more of modules 26, 28, and 32) and generate output, such as report specifications. In those examples where recommendation engine 30 is contained in other devices, recommendation engine 30 may receive requests and output data via enterprise network 18. In one example, recommendation engine 30 may receive a request from report module 28 for potential report specifications. The request may be accompanied by the data elements to be included in the report (e.g., as specified by user 12A). In some examples, the request may also include an indication of a class that defines the possible report specification structures and possible report specification options. In other examples, recommendation engine 30 may automatically determine the relevant class based on the request. In any case, recommendation engine 30 may include instructions operable by processors 20 via memory units 21 to determine one or more configurations of the input data (e.g., report specifications) that provide insight into the data elements, based at least in part on the knowledge base, and may provide the determined report specifications to report module 28. That is, recommendation engine 30 may receive data elements as input, determine one or more potential report specifications for the received data elements based at least in part on the class definition, rules, and/or templates for a report specification, score each of the potential report specifications based on criteria defined within the class, and output the scored potential report specifications to report module 28.

Recommendation engine 30 may receive an indication of a selected potential report specification from report module 28, generate the selected report specification for the received data elements, and provide the report specification to report module 28. In some examples, a recommendation provided by recommendation engine 30 may be a complete object, selectable by the user (e.g., using one of input devices 36) to specify a choice for all report options (e.g., type of graph, color scheme, layout, display options, and other options). Report module 28 may receive an indication of the selected object from UI module 32 and provide the selected object to recommendation engine 30. In response to receiving the selected object, recommendation engine 30 may generate the corresponding report specification and send the report specification to report module 28. In other examples, a user may pick and choose various options from the recommended objects (e.g., a type of graph from the first recommended report specification, a color scheme from the third, and so on). In the case of a user selecting various options from multiple potential report specifications, report module 28 may receive various indications of the selections from UI module 32, and provide the selections to recommendation engine 30. Recommendation engine 30 may receive the selections, and generate a report specification based at least in part on one or more of the received selections. That is, in some examples a user may be able to select a specific object, while in other examples, the user may select options from one or more objects.

In another example, recommendation engine 30 may receive a request for recommendations from query module 26. The request may include data indicating the desired results of a query. Recommendation engine 30 may determine potential query structures to obtain the desired results based on the knowledge base, and may output the potential query structures to query module 26 (e.g., for review by user 12A). In some examples, the outputted potential query structures may be ranked by recommendation engine 30. Recommendation engine 30 may receive an indication of a selected potential query structure, or one or more selected options of the potential query structures, from query module 26. Recommendation engine 30 may generate the selected query, and provide the generated query to query module 26.

In yet other examples, recommendation engine 30 may receive requests from other components (e.g., one or more components not shown in FIG. 2) to provide recommendations for other classes. Responsive to receiving the request, recommendation engine 30 may determine potential results (e.g., a configuration of the output data) based on the knowledge base. In some examples, recommendation engine 30 may rank the results using criteria defined by the knowledge base. Recommendation engine 30 may output the potential results for review by a user. Recommendation engine 30 may receive a selected potential result, generate the selected potential result (e.g., as applied to the received data), and provide the generated result as output.

In some examples, recommendation engine 30 may perform techniques of the present disclosure without requiring input from user 12A. That is, recommendation engine 30 may be operable to generate an output object without the user taking action to select a variation. For instance, recommendation engine 30 may receive a request for recommendations or other data indicating a request for immediate output. Responsive to receiving the request, recommendation engine 30 may determine one or more potential output objects and rank the objects based on scores associated with the potential output objects. However, instead of outputting the potential output objects to one or more components of computing device 16A, recommendation engine 30 may proceed as if the highest ranked potential output was selected by user 12A. In other words, if report module 28, query module 26, or other modules send a request to recommendation module 30 for immediate output, recommendation module 30 may automatically choose the highest ranked recommended output object, and use the chosen output object to generate a configuration of the input data.

By generating recommendations and/or an a resolved output, recommendation engine 30 may enable computing device 16A to assist users in generating report specifications, reports, queries, or any other class of objects by using class definitions 38, rules 39, and templates 40 to generate a knowledge including the specific class of objects, provide a ranking of possible outputs for the class, based on the knowledge base and specified inputs, receive a selection of one or more of the possible outputs from a user, and generate the selected output or outputs. That is, one or more techniques of the present disclosure may provide an externalized, template-driven, nondeterministic recommendation engine for causing a computing device to assist in the creation of report specifications, reports, queries, and other outputs, based on administrator-defined structure and user-defined data input. Recommendation engine 30 is further described with respect to FIG. 3 below.

FIG. 3 is a block diagram illustrating example operations that may be performed by recommendation engine 30 as shown in FIG. 2, in accordance with one or more aspects of the present disclosure. For purposes of illustration only, the example shown in FIG. 3 is described in the context of computing device 16A and enterprise business intelligence system 14 as shown in FIGS. 1 and 2. Grouping 60 may, in some examples, include sub-components and operations taking place within recommendation engine 30. In the example of FIG. 3, recommendation engine 30 may include template parser/resolver 62, variation tree generator 68, variations serializer 72, and variation tree resolver 74.

Report class definition 64, report rules 65 and report templates 66 may be files or documents created by administrators, developers, or other entities. Template parser/resolver 62 may be operable to retrieve (e.g., upon initiation) report class definition 64, report rules 65, and/or report templates 66 from storage devices 22. Based at least in part on report class definition 64, report rules 65, and/or templates 66, template parser/resolver 62 may generate a knowledge base for, among other things, recommending and generating report specifications. While the example of FIG. 3 is described with respect to generation of report specifications, various other objects may be used in other examples. For instance, the process of FIG. 3 may readily be applied to query recommendation and generation, report recommendation and generation, or other object classes.

In generating the knowledge base, template parser/resolver 62 may generate a parameter tree for a particular class based on definition sections within the class and store the parameter tree within the knowledge base. The definition sections of the knowledge base, in some examples, may include a section defining the structure of a parameter tree for the class, scoring information for the parameter tree, and validation information for the parameter tree.

A parameter tree may be comprised of one or more parameter objects. Parameter objects can have any number of types, including basic parameter types, stored within recommendation engine 30, and/or dependent parameter types, defined by individual parameter definitions (e.g., within one of class definitions 38). In some examples, a “parameter”-type parameter may be the most basic parameter, extendable to provide a new leaf type parameter (e.g., a node of the parameter tree not having any children). Recommendation engine 30 may also include a “parent”-type parameter as a basic parameter type. The parent-type parameter may contain a set of child parameters and may be extended to provide a new non-leaf parameter type (e.g., a node of the parameter tree that has one or more children). The basic parameter types may also include a multivariable-type parameter, usable by recommendation engine 30 to create a set of variations representing different orderings and combinations of the children of this parameter. In some examples, each combination of children of a multivariable-type parameter represents a single variation. A dependent-type parameter may also be included in the basic parameter types within recommendation engine 30. The dependent-type parameter may be dependent on values assigned to other parameters. For example, the dependent-type parameter may be useful for adding logic that depends on the values assigned to multiple other parameters, rather than just the ancestors (e.g., parent node, grandparent node, and so on) of the current parameter. Each of the basic parameter types may be extended (e.g., via definitions within one of class definitions 38) to meet the specific needs of users in various situations. That is, while recommendation engine 30 may initially recognize only basic parameter types, administrators, developers, and/or users may extend the basic parameter types, allowing recommendation engine 30 to potentially deal with numerous possible parameter types.

Parameters may each implement a parameter interface. Similar to parameters themselves, parameter interfaces may be created and deployed for use with recommendation engine 30 by developers, administrators, or users. That is, recommendation engine may, in various instances, be able to handle parameters implementing any number of different possible parameter interfaces. Initially, recommendation engine 30 may recognize a number of basic interface types.

The basic interface type may include a conditional-type interface, allowing a parameter to be referenced by a conditional control statement in a template. In some examples, a parameter implementing the conditional-type interface may employ one or more conditions defined in rules 39. That is, rules 39 may contain various condition definitions for use by the conditional-type interface. For instance, defined conditions within rules 39 may include conditions such as a “has more than one value” condition, a “has time data” condition, a “has negative values” condition, or other conditions. In this way, rules 39 may allow a single parameter type or parameter interface access to various options. Additionally, rules 39 may allow multiple parameter types or parameter interfaces access to options available to other parameter types or parameter interfaces.

Another example interface type includes the scorable-type interface. A parameter that implements the scorable-type interface may be able to provide a score that will be added to a total score for a given variation if the parameter is included in a branch that is traversed in the given variation. That is, parameters implementing the scorable-type interface may be used to determine the score for a particular variation of a variation tree. A validation-type parameter interface may also be recognizable by recommendation engine 30. A parameter that implements the validation-type interface may provide a true or false value. When recommendation engine 30 walks a variation tree, if a false value is encountered, recommendation engine 30 may discard the variation. Other examples of parameter interfaces include a value-type interface, enabling the parameter to be referenced by a control statement that writes a value to the output, a scope-type parameter, enabling the parameter to change the data available to child parameters for resolution purposes, a resolvable-type interface, enabling the parameter to be bound to input data 70 during the resolution stage, or a multi-resolvable-type parameter, enabling the parameter to be bound to multiple choices of data. A resolution-group-type interface may also be recognized by recommendation engine 30, allowing the parameter that produces variations to restrict the variation choices to those choices not assigned to other parameters in the same resolution group. For example, two parameters of the same resolution group may have the same two possible variations. If the first parameter of the group selects the first variation, the second parameter of the group may pick the second.

In the example of FIG. 3, template parser/resolver 62 may determine a report parameter tree based on the definition sections within report class definition 64, and store the report parameter tree within the knowledge base. Recommendation engine 30 may receive a request from report module 28 for report specification recommendations. The request may include an indication of the data elements that are to be included in a report specification (e.g., as defined by user 12A). Template parser/resolver 62 may receive the request and, in response, may access the knowledge base and retrieve the report parameter tree. Template parser/resolver 62 may provide the parameter tree to variation tree generator 68.

Variation tree generator 68 may be operable to create a complete description of all variations for a given parameter tree and a given set of input data 70. That is, variation tree generator 68 may determine a variation tree that captures all of the choice points within the received parameter tree (e.g., defined by variable-type parameters), and all of input data 70 provided by the requesting application or module, in order to create an output. Variation tree generator 68 may receive the parameter tree from template parser/resolver 62. Variation tree generator 68 may also receive input data 70 (e.g., from report module 28). In one example, variation tree generator 68 may determine the variation tree by applying input data 70 to the received parameter tree, and mapping the parameters of the parameter tree to the variation tree.

Mapping a parameter from the parameter tree to a variation tree may depend on the parameter interface that the particular parameter implements. For example, when variation tree generator 68 encounters a parameter implementing a resolvable-type interface, variation tree generator 68 may copy the parameter into the variation tree and resolve the parameter (e.g., by calling a resolve method of the parameter class). Resolving a parameter may, in some examples, mean executing logic contained within the parameter, based on the input to the parameter. For instance, resolving a parameter implementing a value-type interface may include assigning a value to the parameter. As another example, resolving a parameter implementing a multi-resolvable-type interface may include determining possible choices for the parameter, and creating a choice point in the variation tree.

If variation tree generator 68 encounters a parameter implementing a scope-type interface, in the parameter tree, variation generator 68 may copy the parameter into the variation tree, and use the parameter (e.g., by calling a method of the parameter class) to change the resolve method of descendent parameters that implement the resolvable-type interface to a resolve method specified by the parameter implementing the scope-type interface. That is, parameters implementing the scope-type interface may modify the way in which child, or descendent, parameters implementing the resolvable-type interface are resolved. In response to encountering a parent-type parameter that implements a conditional-type interface, variation tree generator 68 may copy the parameter to the variation tree, but only copy the parameter's child parameters to the variation tree if the condition is determined to be met. That is, parent-type parameters implementing the conditional-type interface allow for logic within the descendent parameters to be executed on a conditional basis. In some examples, such as where the parameter implementing the conditional-type interface contains an else statement, descendent parameters are copied to the variation tree regardless of whether the condition is determined to be met. Various other parameter types, implementing various other interfaces, as well as associated procedures for mapping parameters to a variation tree may be defined by recommendation engine 30 or by administrators, developers, or other entities (e.g., through creation of class definitions 38).

Variation tree generator 68 may continue to determine the variation tree until the entire received parameter tree has been traversed. Variation tree generator 68 may then provide the determined variation tree to variations serializer 72 to score each possible variation. Variation tree generator 68 may also provide the determined variation tree to variation tree resolver 74 in order to resolve a selected variation.

Variations serializer 72 may receive the variation tree from variation tree generator 68 and traverse the variation tree's choice points to enumerate all possible variations that can be produced by the tree. In some examples, variations serializer 72 may traverse the variation tree through recursion. For each possible variation, variations serializer 72 may create a unique key (e.g., a serialization key) allowing for reconstruction of the variation (e.g., a specific configuration of input data 70). A serialization key may include data that describes a single way in which the variation tree can be walked. The serialization key for each variation may, for instance, be recorded in a tree serialization notation that contains indexes at each choice point parameter within the variation tree. The serialization keys may define which child parameter is (or which child parameters are) the active choice for each choice point.

In one non-limiting example, a serialization key recorded in a tree serialization notation may be represented by (0-1,(0-1-2, 1),0,0,0). This example serialization key contains two types of identifiers. Single numbers in the example serialization key may represent the identity of the child index chosen, for example, for a variable-type parameter (e.g., the active choice for the associated choice point). The dash-separated identifiers (e.g., 0-1) may represent the order and identity of the child indexes chosen for a multivariable-type parameter (e.g., the active choices for the associated choice point). This example serialization key may describe only one way to serialize the choices, and many other possible methods may exist.

Variations serializer 72 may also determine a score associated with each serialization key. A score may be a numerical value that is used to rank the possible variations. In some examples, scores may be obtained by variations serializer 72 by adding all the individual values provided by the scoring parameters in the variation. Parameters implementing a scorable-type interface may contain complex logic executed by applying input data 70 during parameter resolution. For instance, if a parameter implementing a scorable-type interface that returns the number of values in a metric is encountered below a scope-type parameter, variations serializer 72 may add the value of the metric to the final score for the present variation. If different variations contain different metrics in the scope-type parameter, variation serializer 72 may add different values to the total score for each variation.

Variations serializer 72 may enforce a number of guidelines in order to serialize and score the variation tree. For instance, when variations serializer 72 encounters a parameter implementing the scorable-type interface while in a particular variation, variations serializer 72 may add the score for the parameter to a total score for that variation. When variations serializer 72 encounters a parameter implementing the validation-type interface, variations serializer 72 may check the validity of the parameter (e.g., by calling the parameter's validation method). If the parameter is invalid, variation serializer 72 may discard the key. As another example, when variation serializer 72 encounters a variable-type or multivariable-type parameter in a particular variation, variation serializer 72 may create a sub-key for each variation and append the sub-key to a copy of the current key. Variable-type or multivariable-type parameters that implement the resolution-group-type interface may cause variation serializer 72 to ensure that the choices picked for the parameter have not been chosen for other members of the same resolution group. That is, the currently assigned choices for a choice point within a resolution group may be recorded with each of the keys being built, so that assigned choices are not reused for a later choice point within the resolution group.

Once variations serializer 72 has determined a key and score for each variation, variations serializer 72 or another component of recommendation engine 30 may create a list of one or more serialization keys. In some examples, the list may be ordered based on the keys' associated score. That is, the serialization keys may be ranked by their respective scores. In any case, variations serializer 72 may provide the list, including one or more of the serialization keys, to the requesting application or module (e.g., report module 28) for output and consideration by user 12A. The output of the serialization keys for user 12A's consideration is described in further detail with respect to FIG. 4 below.

Variation tree resolver 74 may receive the variation tree from variation tree generator 68. Variation tree resolver 74 may also receive a specific serialization key from user 12A (e.g., via report module 28). Based at least in part on the received variation tree and the received serialization key, variation tree resolver 74 may determine a resolved parameter tree. In some examples, variation tree resolver 74 may reduce the variation tree to a parameter tree by resolving the variation tree. That is, variation tree resolver 74 may choose child parameters of choice points, based on the associated values in the received serialization key. For instance, a variable-type parameter of the variation tree may have two parameters as children. When variation tree resolver 74 encounters the variable-type parameter, variation tree resolver 74 may determine which of the two child parameters is the active choice, based on the received serialization key, and may copy the selected child parameter to the resolved parameter tree in place of the variable-type parameter. In other words, variation tree resolver 74 may remove the choice points in the variation tree, and apply the active choices as defined by the specified serialization key. In this way, variation tree resolver 74 may reduce the variation tree, having a number of choice points each with a plurality of choices, down to a resolved parameter tree that has all choices and/or options determined. The resolved parameter tree may then be provided to template parser/resolver 62.

Template parser/resolver 62 may receive the resolved parameter tree from variation tree resolver 74, and may apply the resolved parameter tree using one or more templates within the knowledge base. The templates may describe how to apply the data in the resolved parameter tree into an output. In some examples, template parser/resolver 62 may copy the static content directly to the output. In other examples, a control statement surrounding the static content may specify other actions. Template parser/resolver 62 may use control statements in combination with the parameters of the resolved parameter tree to generate content for the output.

Template parser/resolver 62 may generate different types of content based on the type of control statement encountered in the template and/or the type of parameter referenced by the statement. In various non-limiting examples, template parser/resolver 62 may encounter a conditional control statement (e.g., “if,” “then,” or “else”) which operates on parameters implementing the conditional-type interface. Based on the control statement encountered, template parser/resolver 62 may determine whether or not to include, in the output, the content contained within the statement. A switch control statement may operate on variable-type parameters. In response to encountering a switch control statement, template parser/resolver 62 may only include the content within the active variation in the output. An encountered “valueof” control statement may cause template parser/resolver 62 to include the value within a referenced parameter that implements the value-type interface in the output. In various examples, other types of control statements may cause template parser/resolver 62 to include one or more other types of content in accordance with techniques of the present disclosure.

In the example of FIG. 3, template parser/resolver 62 may extract information from the resolved parameter tree. Template parser/resolver 62 may include the information from the relevant parameter in the proper locations of resolved report specification 76, according to control statements in one of report templates 66. Template parser/resolver 62 may output the configuration, as resolved report 76, to report module 28. In accordance with techniques of the present disclosure, report module 28 may generate one or more reports 17. The modules and operations within grouping 60 may provide user 12A with a template-driven, nondeterministic recommendation engine capable of providing any number of output classes, depending on the class definitions, rules, and/or templates received.

FIG. 4 is a block diagram illustrating an example graphical user interface 80 (GUI) for providing a recommendation engine, in accordance with one or more aspects of the present disclosure. For purposes of illustration only, the example shown in FIG. 4 is described in the context of computing device 16A and enterprise business intelligence system 14 as shown in FIGS. 1 and 2.

GUI 80 may represent one example of a GUI for displaying, to user 12A, potential outputs or recommendations generated by recommendation engine 30. In accordance with one or more techniques of the present disclosure, recommendation engine 30 may output one or more serialization keys and/or associated scores (e.g., to report module 28) in response to receiving a request for potential report specifications. Report module 28 may receive the serialization keys and generate GUI 80. Report module 28 may send GUI 80 to UI module 32 for display at one or more of output devices 34.

As shown in FIG. 4, GUI 80 contains tabs 82 and 84, chart types 86A-86H (collectively “chart types 86”), chart sub-types 88A-88D (collectively “chart sub-types 88”), recommendation areas 90A and 90B (collectively “recommendation areas 90”), description 92, reasoning 94, and submit button 96. GUI 80 is only one possible example of a GUI for presenting recommendations determined by recommendation engine 30, and various other GUIs may be used in other examples. That is, GUIs for other object classes, such as queries, or other methods of selecting a recommendation may be represented in different ways, using more or fewer elements. For instance, while GUI 80 may allow user 12A to select a complete, specific report specification for generating one of reports 17, other possible GUIs may allow user 12A to select different choices for, or “mix and match,” report options. In some examples, computing device 16A may not output any GUI, such as when recommendation engine 30 automatically chooses the highest ranked recommendation.

In the example of GUI 80, tab 82 may represent a user-selectable object to display the potential report specifications in an ordered or ranked format based on the scored associated with the key for each potential report specification. In some examples, the ranked potential report specifications may only include a certain number of potential report specifications. For instance, GUI may, in some examples, include only the top 10 potential report specifications, the top 5, or any other number. Tab 84 may represent a user-selectable object to cause output devices 34 to display the potential report specifications in an unranked format, such as alphabetically by chart type. For instance, in some examples, by selecting tab 84, user 12A may cause all potential report specifications to be displayed, regardless of the score associated with the potential report specification.

Chart types 86, as shown in GUI 80, may each be a user-selectable object for displaying the potential report specification or report specifications that correspond to the particular chart type. In some examples, chart types 86 may be organized based on the ranking of the underlying potential report specifications. In the example of FIG. 4, for instance, the serialization key having the highest score value may correspond to a potential report specification including a line chart. The serialization key having the second highest score value may correspond to a line chart or an area chart, and so on. In other examples, chart types 86 may be organized in some other fashion, such as alphabetically by type of chart. Chart types 86 may be selectable by user 12A to display potential report specifications including the particular type of chart. For instance, in the example of FIG. 4, user 12A may have previously selected chart type 86A, labeled “Line Chart,” and thus line charts are displayed in GUI 80.

GUI 80 may also include chart sub-types 88. Chart sub-types 88 may each be a user-selectable object for causing output devices 34 to display potential report specifications having charts of the same type of chart and the same sub-type. In some examples, chart sub-types 88 may be organized based on the ranking of the underlying potential report specifications. In other examples, chart sub-types 88 may be arranged in some other way. In the example of FIG. 4, chart sub-type 88A, labeled “Line Chart Type 1,” may be selected and, as a result, GUI 80 may display for selection only those potential report specifications which have a line chart of the “Line Chart Type 1” sub-type.

Recommendation areas 90 may also be included in GUI 80. Recommendation areas 90 may each be a user-selectable object representing a specific potential report specification. For instance, recommendation area 90A may be usable (e.g., by recommendation engine 30 and/or report module 28) to generate a line chart, of a “Line Chart Type 1” sub-type, having a “Year” dimension of the input data assigned to the X-axis of the chart, where different colored lines represent one or more different product lines, and the lines themselves represent revenue values. Recommendation area 90B may be a potential report specification useable to generate another line chart of a “Line Chart Type 1” sub-type, having a “Product Line” dimension of the input data assigned to the X-axis of the chart, where different colors represent one or more different years, and the lines themselves represent revenue values. In some examples, more or fewer details may be shown for each of recommendation areas 90. For instance, recommendation areas 90 may, in one example, include information about another dimension in the chart (e.g., sales region), information about the visual display of the chart (e.g., a three-dimensional chart or a two-dimensional chart), or other information. Recommendation areas 90 may include a radial button or other selectable object allowing user 12A to select a specific recommendation for resolution by recommendation engine 30.

GUI 80 may, in some examples, include description 92 and reasoning 94. Description 92 may include text describing the selected one of chart types 86, chart sub-types 88, and/or recommendation areas 90. As shown in the example of FIG. 4, description 92 may describe general traits of line charts, corresponding to a selection of chart type 86A. Reasoning 94 may provide details about why a selected one of recommendation areas 90 was recommended by recommendation engine 30. That is, reasoning 94 may explain the scoring of the serialization key corresponding to the selected potential report specification. In some examples, the information included in reasoning 94 may be determined by recommendation engine 30 (e.g., based on class definitions 38, rules 39, and/or templates 40).

GUI 80, as shown in FIG. 4, may include submit button 96. Select button 96 may, in some examples, include a user-selectable object for committing the user's selection of one of recommendation areas 90. For instance, after selecting a potential report specification (e.g., recommendation area 90A), user 12A may select submit button 96 (e.g., using one of input devices 36).

UI module 32 may receive an indication of the input, and provide the indication to report module 28. Responsive to receiving the indication, report module 28 may send data indicating the selected potential report object to recommendation engine 30 in accordance with one or more techniques of the present disclosure. By providing a nondeterministic recommendation engine, computing device 16A may enable user 12A to choose a potential report specification or other class of output object, thereby potentially avoiding the restriction of user 12A's options.

FIG. 5 is a flowchart illustrating an example process for providing a recommendation, in accordance with one or more aspects of the present disclosure. For purposes of illustration only, the example process is described below within the context of computing device 16A and enterprise business intelligence system 14, as shown in FIGS. 1 and 2.

In the example of FIG. 5, computing device 16A may receive a first request for a recommendation to configure input data for output, wherein the first request comprises the input data, at process element 200. Computing device 16A may determine, based at least in part upon one or more templates, an object class corresponding to the first request at process element 202. Computing device 16A may determine, based at least in part on the input data and the one or more templates, one or more output objects and one or more scores, wherein the one or more output objects each comprise a configuration of the input data for the determined object class, and wherein each of the one or more output objects is associated with a score of the one or more scores at process element 204. Computing device 16A may output a first indication of the one or more output objects having an associated score that exceeds a specified threshold value at process element 206. Responsive to receiving a second request to resolve a specified output object of the one or more output objects, computing device 16A may determine, based at least in part on the one or more templates and the second request, a resolved output object at process element 208. Computing device 16A may output a second indication of the resolved output object at process element 210.

In some examples, determining the one or more output objects and the one or more scores further comprises determining, based at least in part on the one or more templates, a parameter tree including one or more variable parameters, and determining, based at least in part on the parameter tree and the input data, a variation tree, wherein the one or more variable parameters of the parameter tree are mapped to one or more respective choice points of the variation tree, each choice point associated with a plurality of choices, wherein each of the one or more output objects corresponds to one or more choices for each of the respective choice points. In some examples, determining the one or more output objects and the one or more scores further comprises determining, based at least in part on the variation tree, one or more serialization keys defining a variation of the variation tree, each serialization key associated with one of the one or more scores, and the first indication comprises the one or more serialization keys.

In some examples, the second request to resolve the specified output object comprises a particular serialization key of the one or more serialization keys. In some examples, determining the resolved output object comprises determining, based at least in part on the particular serialization key and the variation tree, a resolved parameter tree, wherein each respective choice point and associated plurality of choices of the variation tree is mapped in the resolved parameter tree to one or more choices of the plurality of choices for the respective choice point. In some examples, outputting the first indication comprises outputting an ordered list of the one or more output objects, the ordered list being ordered based at least in part on the score associated with each of the one or more output objects. In some examples, determining the object class corresponding to the first request comprises determining a report specification class.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. A computer-implemented method, comprising:
receiving, by a computing device, a first request for a recommendation to configure input data for output, wherein the first request comprises the input data;
determining, by the computing device and based at least in part upon one or more templates, an object class corresponding to the first request;
determining, by the computing device and based at least in part on the input data and the one or more templates, one or more output objects and one or more scores, wherein the one or more output objects each comprise a configuration of the input data for the determined object class, and wherein each of the one or more output objects is associated with a score of the one or more scores;
outputting, by the computing device, a first indication of the one or more output objects having an associated score that exceeds a specified threshold value;
responsive to receiving a second request to resolve a specified output object of the one or more output objects, determining, by the computing device and based at least in part on the one or more templates and the second request, a resolved output object; and
outputting, by the computing device, a second indication of the resolved output object.

2. The method of claim 1, wherein determining the one or more output objects and the one or more scores further comprises:
determining, based at least in part on the one or more templates, a parameter tree including one or more variable parameters; and
determining, based at least in part on the parameter tree and the input data, a variation tree, wherein the one or more variable parameters of the parameter tree are mapped to one or more respective choice points of the variation tree, each choice point associated with a plurality of choices,
wherein each of the one or more output objects corresponds to one or more choices for each of the respective choice points.

3. The method of claim 2, wherein determining the one or more output objects and the one or more scores further comprises determining, based at least in part on the variation tree, one or more serialization keys defining a variation of the variation tree, each serialization key associated with one of the one or more scores, and wherein the first indication comprises the one or more serialization keys.

4. The method of claim 3, wherein the second request to resolve the specified output object comprises a particular serialization key of the one or more serialization keys.

5. The method of claim 4, wherein determining the resolved output object comprises:
determining, based at least in part on the particular serialization key and the variation tree, a resolved parameter tree, wherein each respective choice point and associated plurality of choices of the variation tree is mapped in the resolved parameter tree to one or more choices of the plurality of choices for the respective choice point.

6. The method of claim 1, wherein outputting the first indication comprises outputting an ordered list of the one or more output objects, the ordered list being ordered based at least in part on the score associated with each of the one or more output objects.

7. The method of claim 1, wherein determining the object class corresponding to the first request comprises determining a report specification class.

8. A computing device comprising:
at least one processor;
a user interface module operable by the at least one processor to receive a first request for a recommendation to configure input data for output, wherein the first request comprises the input data; and
a recommendation engine operable by the at least one processor to:
determine, based at least in part upon one or more templates, an object class corresponding to the first request, and
determine, based at least in part on the input data and the one or more templates, one or more output objects and one or more scores, wherein the one or more output objects each comprise a configuration of the input data for the determined object class, and wherein each of the one or more output objects is associated with a score of the one or more scores;
wherein the user interface module is further operable by the at least one processor to:
output a first indication of the one or more output objects having an associated score that exceeds a specified threshold value, and
receive a second request to resolve a specified output object of the one or more output objects;
wherein the recommendation engine is further operable by the at least one processor to determine, based at least in part on the one or more templates and the second request, a resolved output object; and
wherein the user interface module is further operable by the at least one processor to output a second indication of the resolved output object.

9. The computing device of claim 8, wherein the recommendation engine operable to determine the one or more output objects and the one or more scores is further operable to:
determine, based at least in part on the one or more templates, a parameter tree including one or more variable parameters; and
determine, based at least in part on the parameter tree and the input data, a variation tree, wherein the one or more variable parameters of the parameter tree are mapped to one or more respective choice points of the variation tree, each choice point associated with a plurality of choices,
wherein each of the one or more output objects corresponds to one or more choices for each of the respective choice points.

10. The computing device of claim 9, wherein the recommendation engine operable to determine the one or more output objects and the one or more scores is further operable to determine, based at least in part on the variation tree, one or more serialization keys defining a variation of the variation tree, each serialization key associated with one of the one or more scores,
wherein the first indication comprises the one or more serialization keys.

11. The computing device of claim 10, wherein the second request to resolve the specified output object comprises a particular serialization key of the one or more serialization keys.

12. The computing device of claim 11, wherein the recommendation engine operable to determine the resolved output object is further operable to determine, based at least in part on the particular serialization key and the variation tree, a resolved parameter tree,
wherein each respective choice point and associated plurality of choices of the variation tree is mapped in the resolved parameter tree to one or more choices of the plurality of choices for the respective choice point.

13. The computing device of claim 8, wherein the user interface module operable to output the first indication is further operable to output an ordered list of the one or more output objects, the ordered list being ordered based at least in part on the score associated with each of the one or more output objects.

14. The computing device of claim 8, wherein the recommendation engine operable to determine the object class corresponding to the first request is further operable to determine a report specification class.

15. A computer program product comprising a computer readable storage medium having program code embodied therewith, the program code executable by a computing device to perform a method comprising:
receiving, by the computing device, a first request for a recommendation to configure input data for output, wherein the first request comprises the input data;
determining, by the computing device and based at least in part upon one or more templates, an object class corresponding to the first request;
determining, by the computing device and based at least in part on the input data and the one or more templates, one or more output objects and one or more scores, wherein the one or more output objects each comprise a configuration of the input data for the determined object class, and wherein each of the one or more output objects is associated with a score of the one or more scores;
outputting, by the computing device, a first indication of the one or more output objects having an associated score that exceeds a specified threshold value;
responsive to receiving a second request to resolve a specified output object of the one or more output objects, determining, by the computing device and based at least in part on the one or more templates and the second request, a resolved output object; and
outputting, by the computing device, a second indication of the resolved output object.

16. The computer program product of claim 15, wherein determining the one or more output objects and the one or more scores further comprises:
determining, based at least in part on the one or more templates, a parameter tree including one or more variable parameters; and
determining, based at least in part on the parameter tree and the input data, a variation tree, wherein the one or more variable parameters of the parameter tree are mapped to one or more respective choice points of the variation tree, each choice point associated with a plurality of choices,
wherein each of the one or more output objects corresponds to one or more choices for each of the respective choice points.

17. The computer program product of claim 16, wherein determining the one or more output objects and the one or more scores further comprises determining, based at least in part on the variation tree, one or more serialization keys defining a variation of the variation tree, each serialization key associated with one of the one or more scores, and wherein the first indication comprises the one or more serialization keys.

18. The computer program product of claim 17, wherein the second request to resolve the specified output object comprises a particular serialization key of the one or more serialization keys.

19. The computer program product of claim 18, wherein determining the resolved output object comprises:
determining, based at least in part on the particular serialization key and the variation tree, a resolved parameter tree, wherein each respective choice point and associated plurality of choices of the variation tree is mapped in the resolved parameter tree to one or more choices of the plurality of choices for the respective choice point.

20. The computer program product of claim 15, wherein outputting the first indication comprises outputting an ordered list of the one or more output objects, the ordered list being ordered based at least in part on the score associated with each of the one or more output objects.
